(19) United States
(12) Patent Application Publication
(10) Pub. No.: US 2025/0042304 A1
(43) Pub. Date: Feb. 6, 2025

(54) VEHICLE CONTROL SYSTEM

(71) Applicant: TOYOTA JIDOSHA KABUSHIKI KAISHA, Toyota-shi (JP)

(72) Inventor: Shohei MATSUOKA, Toyota-shi (JP)

(73) Assignee: TOYOTA JIDOSHA KABUSHIKI KAISHA, Toyota-shi (JP)

(21) Appl. No.: 18/626,521

(22) Filed: Apr. 4, 2024

(30) Foreign Application Priority Data
Jul. 31, 2023 (JP) 2023-124073

(51) Int. Cl. B60L 58/26; B60L 58/16

(52) U.S. Cl. CPC B60L 58/26; B60L 58/16

(57) ABSTRACT

The vehicle control system according to the present disclosure includes: a data collection unit that collects data related to travel characteristics of each of a plurality of vehicles; an analysis unit that analyzes travel characteristics common to vehicles belonging to at least one of a predetermined area and a predetermined vehicle type among the plurality of vehicles using the collected data; and a control unit that causes each of the vehicles belonging to at least one of the predetermined area and the predetermined vehicle type among the plurality of vehicles to apply common setting contents related to the vehicle equipment based on an analysis result by the analysis unit.

### CROSS-REFERENCE TO RELATED APPLICATION

This application claims priority to Japanese Patent Application No. 2023-124073 filed on Jul. 31, 2023, incorporated herein by reference in its entirety.

### BACKGROUND

### 1. Technical Field

The present disclosure relates to a vehicle control system.

### 2. Description of Related Art

In recent years, development of a technology for optimizing vehicle equipment in accordance with driving characteristics of a user has been advanced. Japanese Unexamined Patent Application Publication No. 2020-158003 (JP 2020-158003 A) discloses a vehicle setting transfer system. The vehicle setting transfer system optimizes equipment of a second vehicle based on characteristic information of a user learned in a first vehicle.

### SUMMARY

The system disclosed in JP 2020-158003 A does not optimize vehicle equipment of a vehicle of another user based on driving characteristics of a user. Therefore, the system disclosed in JP 2020-158003 A has a problem in that common settings related to vehicle equipment cannot quickly be applied to, for example, a plurality of vehicles of a predetermined vehicle type having similar traveling characteristics or a plurality of vehicles that has similar traveling characteristics and travels in a predetermined area.

The present disclosure has been made in view of the above background, and an object of the present disclosure is to provide a vehicle control system that can quickly apply common settings related to vehicle equipment to a plurality of predetermined vehicles.

A vehicle control system according to the present disclosure includes: a data collection unit configured to collect data on traveling characteristics of a plurality of vehicles; an analysis unit configured to analyze traveling characteristics common to vehicles belonging to at least one of a predetermined area and a predetermined vehicle type among the plurality of vehicles by using the collected data; and a control unit configured to apply common settings related to vehicle equipment to the vehicles belonging to at least one of the predetermined area and the predetermined vehicle type among the plurality of vehicles based on a result of analysis performed by the analysis unit. The vehicle control system collects and analyzes the data on the traveling characteristics of the plurality of vehicles, and can therefore quickly apply the common settings related to the vehicle equipment to two or more vehicles belonging to at least one of the predetermined area and the predetermined vehicle type among the plurality of vehicles.

According to the present disclosure, it is possible to provide the vehicle control system that can quickly apply the common settings related to the vehicle equipment to the plurality of predetermined vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of a vehicle control system according to a first embodiment;

FIG. 2 is a flowchart showing an operation of a vehicle control device provided in the vehicle control system shown in FIG. 1;

FIG. 3 is a flowchart illustrating an example of a specific operation of the vehicle control device provided in the vehicle control system illustrated in FIG. 1;

FIG. 4 is a diagram for describing an exemplary operation of a vehicle control device provided in the vehicle control system shown in FIG. 1; and

FIG. 5 is a diagram for explaining an example of an operation of a vehicle control device provided in the vehicle control system shown in FIG. 1.

### DETAILED DESCRIPTION OF EMBODIMENTS

Hereinafter, the present disclosure will be described through embodiments of the disclosure, but the disclosure according to the claims is not limited to the following embodiments. Further, not all of the configurations described in the embodiments are essential as means for solving the problem. For clarity of explanation, the following description and the drawings are omitted and simplified as appropriate. In the drawings, the same elements are denoted by the same reference numerals, and redundant descriptions are omitted as necessary.

### First Embodiment

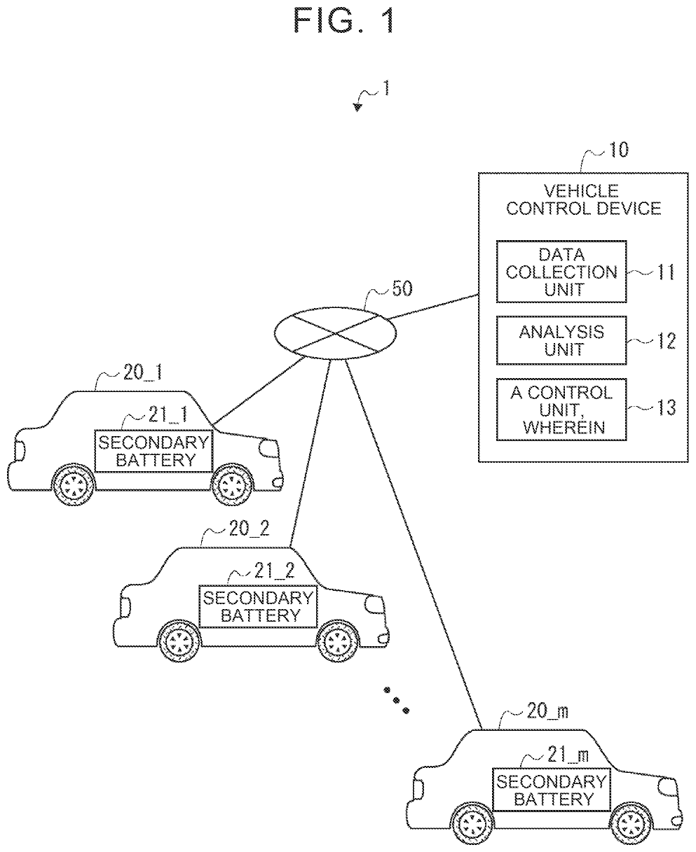

FIG. 1 is a diagram illustrating a configuration example of a vehicle control system 1 according to a first embodiment. The vehicle control system 1 collects and analyzes data related to the traveling characteristics of each of the plurality of vehicles, so that it is possible to promptly apply the common setting contents related to the vehicle equipment to each of two or more vehicles belonging to at least one of the predetermined area and the predetermined vehicle type among the plurality of vehicles. Hereinafter, the first embodiment will be specifically described.

As illustrated in FIG. 1, the vehicle control system 1 includes a vehicle control device 10, vehicles 20_1 to 20_m (m is an integer of 2 or more), and a network 50. The vehicle control device 10 may be referred to as a vehicle control system alone. The vehicle control device 10 and the vehicles 20_1 to 20_m are configured to be able to communicate with each other via a wired or wireless network 50.

Each of the vehicles 20_1 to 20_m is a vehicle such as a battery electric vehicle owned by Um from the user U1. In the present embodiment, the cases where the vehicles 20_1 to 20_m are all battery electric vehicle will be exemplified, but the present disclosure is not limited thereto. All or a part of the vehicles 20_1 to 20_m may be vehicles other than battery electric vehicle such as gasoline-powered vehicles. Rechargeable secondary batteries 21_1 to 21_m such as lithium-ion batteries are mounted on each of the vehicles 20_1 to 20_m.

The vehicle control device 10 is a device that applies common setting contents related to vehicle equipment to each of a plurality of vehicles belonging to at least one of a predetermined area and a predetermined vehicle type among the vehicles 20_1 to 20_m. Specifically, the vehicle control device 10 includes a data collection unit 11, an analysis unit 12, and a control unit 13.

The data collection unit 11 collects data related to the traveling characteristics of the vehicles 20_1 to 20_m. The data relating to the traveling characteristics of the vehicle is, for example, data relating to a traveling distance per predetermined period of the vehicle, a speed per predetermined period of the vehicle (that is, an average speed), or an accelerator operation amount per predetermined period of the vehicle. In addition, the data collection unit 11 also collects data such as the vehicle type, the traveling area, and the fuel efficiency of each of the vehicles 20_1 to 20_m.

Using the data collected by the data collection unit 11, the analysis unit 12 analyzes travel characteristics common to a plurality of vehicles belonging to at least one of a predetermined area and a predetermined vehicle type among the vehicles 20_1 to 20_m. The predetermined area is, for example, an area having a large traffic volume, an area having a large number of unpaved roads, an area having a large number of slopes or curves such as a mountain forest area, or an area having a large number of snow cover. The predetermined vehicle type may be classified by a vehicle having a light weight or a vehicle having a heavy weight.

The analysis unit 12 outputs, for example, an analysis result that the accelerator operation amount per predetermined period is larger than the other areas, as a traveling characteristic common to a plurality of vehicles belonging to a predetermined area having a large slope or curve, such as a mountain forest area, among the vehicles 20_1 to 20_m. Alternatively, the analysis unit 12 outputs, for example, an analysis result that the speed per predetermined period is high as the traveling characteristic common to a plurality of vehicles of a predetermined sport type among the vehicles 20_1 to 20_m.

In particular, using the data collected by the data collection unit 11, the analysis unit 12 analyzes the burden imposed on the secondary battery, which is a degradation factor of the secondary battery mounted on the plurality of vehicles belonging to at least one of the predetermined area and the predetermined vehicle type among the vehicles 20_1 to 20_m. The burden imposed on the secondary battery is, in other words, a load applied to the secondary battery.

For example, the analysis unit 12 determines that the load on the secondary batteries of the plurality of vehicles increases as the travel distance (average value) per predetermined period of the plurality of vehicles belonging to at least one of the predetermined area and the predetermined vehicle type among the vehicles 20_1 to 20_m increases. Further, the analysis unit 12 determines that the load on the secondary batteries of the plurality of vehicles is smaller as the travel distance (average value) per predetermined period of the plurality of vehicles belonging to at least one of the predetermined area and the predetermined vehicle type among the vehicles 20_1 to 20_m is shorter. Alternatively, the analysis unit 12 determines that the higher the speed (average value) per predetermined period of the plurality of vehicles belonging to at least one of the predetermined area and the predetermined vehicle type among the vehicles 20_1 to 20_m, the greater the burden on the secondary batteries of the plurality of vehicles. Further, the analysis unit 12 determines that the load on the secondary batteries of the plurality of vehicles is smaller as the speed (average value) per predetermined period of the plurality of vehicles belonging to at least one of the predetermined area and the predetermined vehicle type among the vehicles 20_1 to 20_m is slower. Alternatively, the analysis unit 12 determines that the burden on the secondary batteries of the plurality of vehicles is larger as the accelerator operation amount (average value) per predetermined period of the plurality of vehicles belonging to at least one of the predetermined area and the predetermined vehicle type among the vehicles 20_1 to 20_m is larger. Further, the analysis unit 12 determines that the load on the plurality of secondary batteries is smaller as the accelerator operation amount (average value) per predetermined period of the plurality of vehicles belonging to at least one of the predetermined area and the predetermined vehicle type among the vehicles 20_1 to 20_m is smaller. The analysis unit 12 may analyze the load on the secondary battery from other traveling characteristics. Then, the analysis unit 12, for example, digitizes the analysis result of the burden on the secondary battery and outputs the result.

Based on the analysis result by the analysis unit 12, the control unit 13 causes each of a plurality of vehicles belonging to at least one of the predetermined area and the predetermined vehicle type among the vehicles 20_1 to 20_m to apply the common setting content related to the vehicle equipment. The setting contents related to the vehicle equipment are the cooling intensity of the secondary battery by a cooling device (not shown), the upper limit value of the current supplied to the secondary battery at the time of charging, the steering feeling, the seat position, and the like.

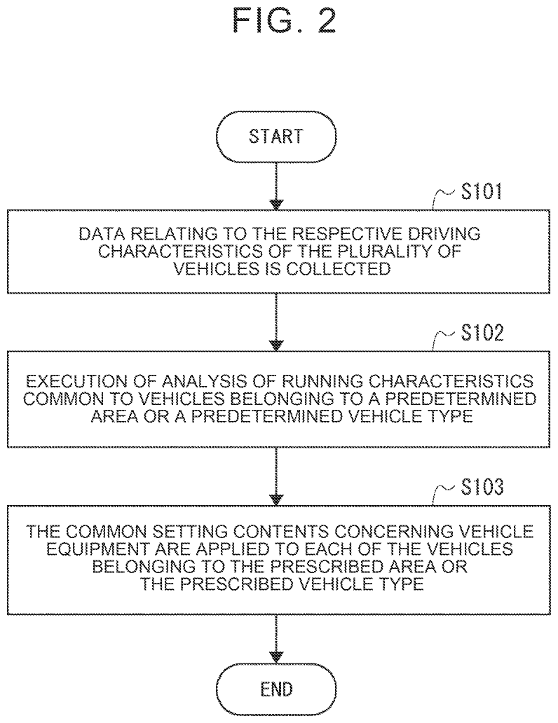

Next, the operation of the vehicle control device 10 will be described with reference to FIG. 2. FIG. 2 is a flowchart illustrating an operation of the vehicle control device 10.

First, the vehicle control device 10 collects data related to the traveling properties of the vehicles 20_1 to 20_m (S101). Thereafter, the vehicle control device 10 analyzes the traveling property shared by the plurality of vehicles belonging to at least one of the predetermined area and the predetermined vehicle type among the vehicles 20_1 to 20_m using the collected data (S102). Thereafter, based on the analysis result, the vehicle control device 10 causes each of the plurality of vehicles belonging to or scheduled to belong to at least one of the predetermined area and the predetermined vehicle type among the vehicles 20_1 to 20_m to apply the common setting content related to the vehicle facility (S103).

As described above, the vehicle control system 1 collects and analyzes data related to the traveling characteristics of each of the vehicles 20_1 to 20_m, so that it is possible to promptly apply the common setting contents related to the vehicle equipment to each of the plurality of vehicles belonging to or belonging to at least one of the predetermined area and the predetermined vehicle type among the vehicles 20_1 to 20_m. Accordingly, the vehicle control system 1 can apply the same setting contents as those of the vehicle of the same vehicle type or the same area to a vehicle such as a new vehicle that does not have the data of the traveling characteristic, for example.

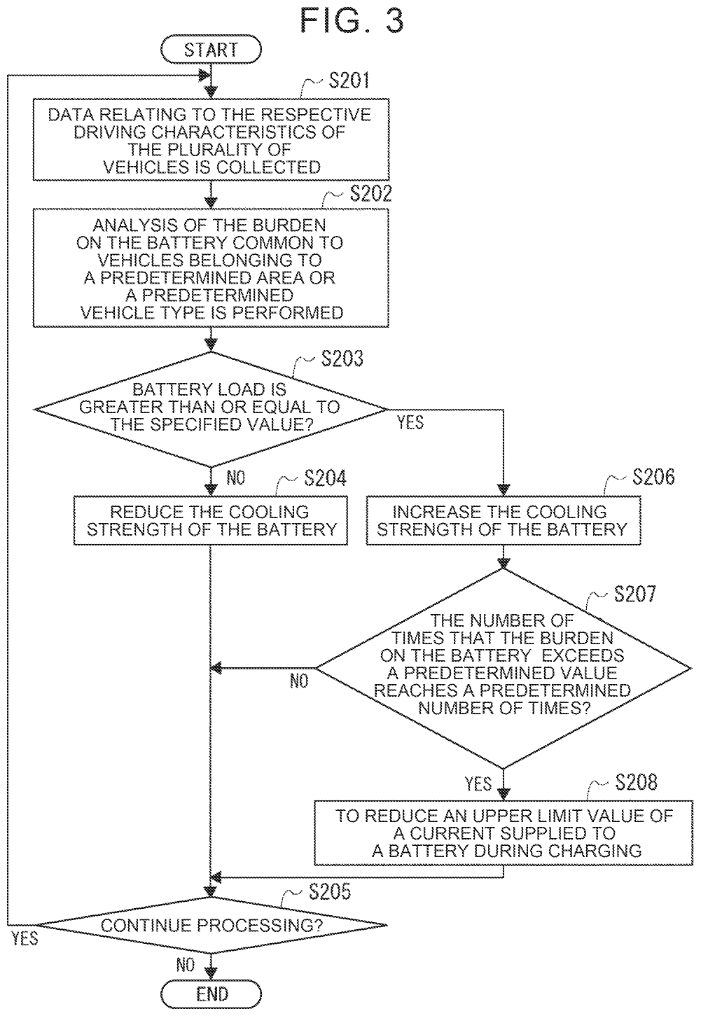

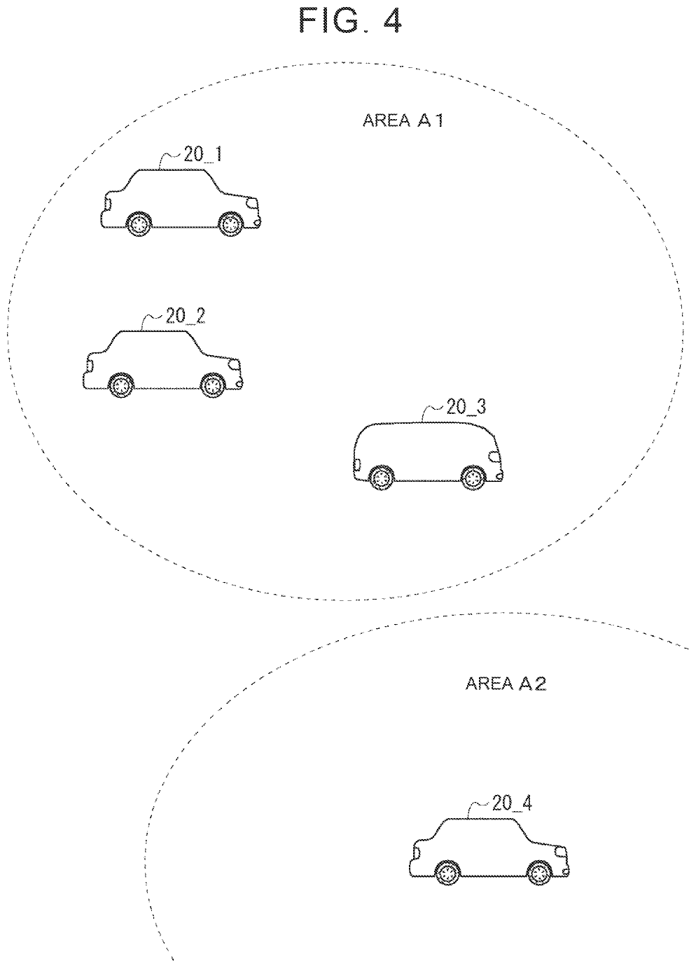

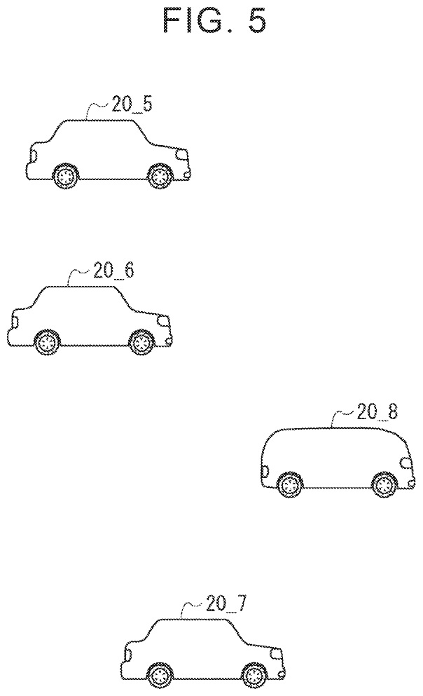

Next, an example of a more specific operation of the vehicle control device 10 will be described with reference to FIG. 3 to FIG. 5. FIG. 3 is a flowchart illustrating an example of a specific operation of the vehicle control device 10. In the example of FIG. 3, a method of setting the cooling intensity by the cooling device of the secondary battery mounted in each vehicle is shown. FIG. 4 and FIG. 5 are diagrams for explaining an example of the operation of the vehicle control device 10.

First, the vehicle control device 10 collects data related to the traveling properties of the vehicles 20_1 to 20_m (S201). Thereafter, the vehicle control device 10 analyzes the burden imposed on the secondary battery, which is a degradation factor of the secondary battery mounted on the plurality of vehicles belonging to at least one of the predetermined area and the predetermined vehicle type among the vehicles 20_1 to 20_m, using the collected data (S202).

For example, when a burden (a numerical value indicating a burden) on the secondary batteries of the plurality of vehicles belonging to at least one of the predetermined area and the predetermined vehicle type among the vehicles 20_1 to 20_m is less than a predetermined value (NO of S203), the vehicle control device 10 weakens or maintains the cooling strength of the secondary batteries of the plurality of vehicles by the cooling device (S204). Accordingly, the load of the cooling process of the cooling devices of the plurality of vehicles is reduced.

On the other hand, when the burden (a numerical value representing the burden) on the secondary batteries of the plurality of vehicles belonging to at least one of the predetermined area and the predetermined vehicle type among the vehicles 20_1 to 20_m is equal to or larger than the predetermined value (YES of S203), the vehicle control device 10 increases the cooling strength of the secondary batteries of the plurality of vehicles by the cooling device (S206). As a result, the burden on the secondary batteries of the plurality of vehicles is reduced, and thus deterioration of the secondary batteries is suppressed.

Further, when the number of times that the load (a numerical value representing the load) applied to the secondary batteries of the plurality of vehicles belonging to at least one of the predetermined area and the predetermined vehicle type among the vehicles 20_1 to 20_m reaches the predetermined number of times (YES of S207), the vehicle control device 10 lowers the upper limit value of the current supplied to the secondary batteries of the plurality of vehicles at the time of charge (S208). As a result, the charging time of the secondary batteries of the plurality of vehicles is increased, but the burden on the secondary batteries is reduced, so that the deterioration of the secondary batteries is further suppressed.

After any one of S204 process, NO process of S207, and S208 process, the vehicle control device 10 returns to the data-collection process (S201) when the process is to be continued (YES of S205), and terminates the process when the process is not to be continued (NO of S205).

In the exemplary embodiment of FIG. 4, among the vehicles 20_1 to 20_4, the vehicles 20_1 to 20_3 are located within a predetermined area A1 having a large slope and a large curve in a forest area or the like. The vehicle control device 10 outputs, for example, an analysis result that the accelerator operation amount per predetermined time period is larger than the other areas (that is, the burden on the secondary batteries 21_1 to 21_3 of the vehicles 20_1 to 20_3 is large) as the traveling characteristic shared by the vehicles 20_1 to 20_3 located in the predetermined area A1. In this case, the vehicle control device 10 increases, for example, the cooling intensity of the secondary batteries 21_1 to 21_3 mounted in the vehicles 20_1 to 20_3 by the cooling device. As a result, the burden on the secondary batteries 21_1 to 21_3 is reduced, and the deterioration of the secondary batteries 21_1 to 21_2 is suppressed.

In the example of FIG. 5, the vehicle types of the vehicles 20_5 to 20_7 among the vehicles 20_5 to 20_8 are the same. The vehicle control device 10 outputs, as the traveling characteristics common to the vehicles 20_5 to 20_7 of the same vehicle type, for example, an analysis result that the speed per predetermined period is slower than that of the other types of vehicles (that is, the burden on the secondary batteries 21_5 to 21_7 of the vehicles 20_5 to 20_7 is small). In this case, for example, the vehicle control device 10 weakens the cooling intensity of the secondary batteries 21_5 to 21_7 mounted in the vehicles 20_5 to 20_7 by the cooling device. As a result, the load of the cooling process of the cooling devices of the secondary batteries 21_1 to 21_3 is reduced.

Note that the common setting contents regarding the vehicle equipment set in the plurality of vehicles by the vehicle control device 10 are not limited to the above-described setting contents. For example, the vehicle control device 10 may reduce the cooling strength of the secondary battery mounted on each of the plurality of heavy vehicles to improve the fuel efficiency, or may increase the cooling strength of the secondary battery mounted on each of the plurality of heavy vehicles to suppress the deterioration of the secondary battery. Alternatively, the vehicle control device 10 may suppress the deterioration of the secondary battery by lowering the upper limit value of the current supplied during charging of the secondary battery mounted in each of the plurality of vehicles located in the low-temperature area throughout the year.

As described above, the vehicle control system 1 collects and analyzes data related to the traveling characteristics of each of the vehicles 20_1 to 20_m, so that it is possible to promptly apply the common setting contents related to the vehicle equipment to each of the plurality of vehicles belonging to or belonging to at least one of the predetermined area and the predetermined vehicle type among the vehicles 20_1 to 20_m. Accordingly, the vehicle control system 1 can apply the same setting contents as those of the vehicle of the same vehicle type or the same area to a vehicle such as a new vehicle that does not have the data of the traveling characteristic, for example.

In addition, some or all of the processes of the vehicle control device 10 can be realized by causing a Central Processing Unit (CPU) to execute a computer program.

The programs described above include instructions (or software code) that, when loaded into a computer, cause the computer to perform one or more of the functions described in the embodiments. The program may be stored in a non-transitory computer-readable medium or a tangible storage medium. By way of example, and not limitation, computer-readable media or tangible storage media include Random-Access Memory (RAM), Read-Only Memory (ROM), flash memory, Solid-state Drive (SSD) or other memory techniques, CD-ROM, Digital Versatile Disc (DVD), Blu-ray disk or other optical disk storage, magnetic cassettes, magnetic tape, magnetic disk storage or other magnetic storage devices. The program may be transmitted on a transitory computer readable medium or a communication medium. By way of example, and not limitation, transitory computer-readable media or communication media include electrical, optical, acoustic, or other forms of propagated signals.

Some or all of the above-described embodiments may be described as the following supplementary notes, but are not limited thereto.

### APPENDIX 1

Vehicle control system, data on the driving characteristics of each of the plurality of vehicles is collected, using the collected data, an analysis of the travel characteristics common to the vehicle belonging to at least one of the predetermined area and the predetermined vehicle type of the plurality of vehicles is performed, based on the analysis result, to each of the vehicles belonging to at least one of the predetermined area and the predetermined vehicle type of the plurality of vehicles, to apply the common setting contents related to the vehicle equipment, vehicle control method.

### APPENDIX 2

A process for collecting data relating to the respective travel characteristics of the plurality of vehicles; a process for analyzing the running characteristics common to the vehicle belonging to at least one of the predetermined area and the predetermined vehicle type of the plurality of vehicles using the collected data, based on the analysis result, a process of applying a common setting content relating to the vehicle equipment to each of the vehicles belonging to at least one of the predetermined area and the predetermined vehicle type among the plurality of vehicles, a control program that causes a computer to execute.

What is claimed is:

1. A vehicle control system comprising:
a data collection unit configured to collect data on traveling characteristics of a plurality of vehicles;
an analysis unit configured to analyze traveling characteristics common to vehicles belonging to at least one of a predetermined area and a predetermined vehicle type among the plurality of vehicles by using the collected data; and
a control unit configured to apply common settings related to vehicle equipment to the vehicles belonging to at least one of the predetermined area and the predetermined vehicle type among the plurality of vehicles based on a result of analysis performed by the analysis unit.

2. The vehicle control system according to claim 1, wherein the control unit is configured to apply the common settings to a vehicle expected to belong to at least one of the predetermined area and the predetermined vehicle type among the plurality of vehicles, the common settings being related to vehicle equipment applied to each of the vehicles belonging to at least one of the predetermined area and the predetermined vehicle type among the plurality of vehicles.

3. The vehicle control system according to claim 1, wherein:
the analysis unit is configured to analyze a load on a battery that causes deterioration of the battery by using the collected data, the battery being mounted on each of the vehicles belonging to at least one of the predetermined area and the predetermined vehicle type among the plurality of vehicles; and
the control unit is configured to increase a cooling intensity for the battery mounted on each of the vehicles belonging to at least one of the predetermined area and the predetermined vehicle type among the plurality of vehicles as the load on the battery increases.

4. The vehicle control system according to claim 3, wherein the control unit is configured to, when determination made by the analysis unit that the load on the battery is large is accumulated a predetermined number of times or more, increase the cooling intensity and reduce an upper limit value of a current to be supplied to the battery during charging of the battery.
